(19) United States
(12) Patent Application Publication
(10) Pub. No.: US 2011/0074211 A1
(43) Pub. Date: Mar. 31, 2011

(54) APPARATUS AND METHOD FOR CONTROLLING THE SWITCHING FREQUENCY OF A POWER CONVERTER

(75) Inventors: Richard Hampo, Plymouth, MI (US); Gary Alan Boothroyd, Farmington Hills, MI (US); Anthony Vincent Panicci, Sterling Heights, MI (US); Daniel Wallace McRobb, White Lake, MI (US)

(73) Assignee: LEAR CORPORATION, Southfield, MI (US)

(21) Appl. No.: 12/878,301

(22) Filed: Sep. 9, 2010

Related U.S. Application Data
(60) Provisional application No. 61/245,838, filed on Sep. 25, 2009.

(51) Int. Cl. B60L 1/00

(52) U.S. Cl. 307/9.1

(57) ABSTRACT

In at least one embodiment, an apparatus for controlling a switching frequency of at least one power switch in a vehicle is provided. The apparatus comprises a power conversion circuit including a power switch. The power conversion circuit is configured to convert a first energy signal into a second energy signal and to control the power switch to operate at a first switching frequency, the first switching frequency generating a first set of harmonics. The power conversion circuit is further configured to receive frequency information from an entertainment device, the frequency information generating a second set of harmonics. The power conversion circuit is further configured to select a second switching frequency, the second switching frequency generating a third set of harmonics. The power conversion circuit is further configured to perform a distance measurement using the first set of harmonics, the second set of harmonics, and the third set of harmonics.

### CROSS-REFERENCE TO RELATED APPLICATIONS

This application claims the benefit of U.S. provisional application Ser. No. 61/245,838 filed on Sep. 25, 2009, which is hereby incorporated by reference in its entirety.

### TECHNICAL FIELD

The embodiments of the present invention generally relate to an apparatus and method for controlling the switching frequency of a power converter in a vehicle.

### BACKGROUND

In order to ensure quality radio reception, vehicle original equipment manufactures (OEMs) generally establish low thresholds for electromagnetic (EM) radiated emissions for various electrical devices positioned within a vehicle. In order to meet such thresholds, various filters and/or shielding mechanisms may be implemented within a particular electrical device to prevent internally generated electrical noise from leaving the electrical device. While these filters and/or shielding mechanisms may be effective in reducing EM radiated emissions, the filters and/or shielding mechanisms may consume space, may be difficult to assemble, and may increase the overall cost of the electrical device.

### SUMMARY

In at least one embodiment, an apparatus for controlling a switching frequency of at least one power switch in a vehicle is provided. The apparatus comprises a power conversion circuit including a power switch. The power conversion circuit is configured to convert a first energy signal into a second energy signal and to control the power switch to operate at a first switching frequency, the first switching frequency generating a first set of harmonics. The power conversion circuit is further configured to receive frequency information from an entertainment device, the frequency information generating a second set of harmonics. The power conversion circuit is further configured to select a second switching frequency, the second switching frequency generating a third set of harmonics. The power conversion circuit is further configured to perform a distance measurement using the first set of harmonics, the second set of harmonics, and the third set of harmonics.

### BRIEF DESCRIPTION OF THE DRAWINGS

The embodiments of the present invention are pointed out with particularity in the appended claims. However, other features of the various embodiments will become more apparent and will be best understood by referring to the following detailed description in conjunction with the accompany drawings in which:

FIG. 1 depicts a system for controlling the switching frequency of a power converter in accordance to one embodiment of the present invention;

FIG. 2 depicts a method for controlling the switching frequency of a power converter in accordance to one embodiment of the present invention.

FIG. 3 depicts an example of a time domain waveform for a first switching frequency and a second switching frequency;

FIG. 4 depicts an example of a frequency domain waveform for the first switching frequency and the second switching frequency; and

FIG. 5 depicts an example of test measurement data obtained from a power converter.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present invention generally provide for, but not limited to, a system and method for adjusting the switching frequency of a power converter in a vehicle. Such a condition may minimize the effect of EM interference in a vehicle for any device in the vehicle that is required to transmit audio and/or video signals for a vehicle occupant. The system and/or method may, among other things, monitor a particular frequency at which the device in the vehicle is tuned to and adjust the switching frequency within the power converter such that switching frequency and its harmonics do not overlap the tuned frequency of the electrical device.

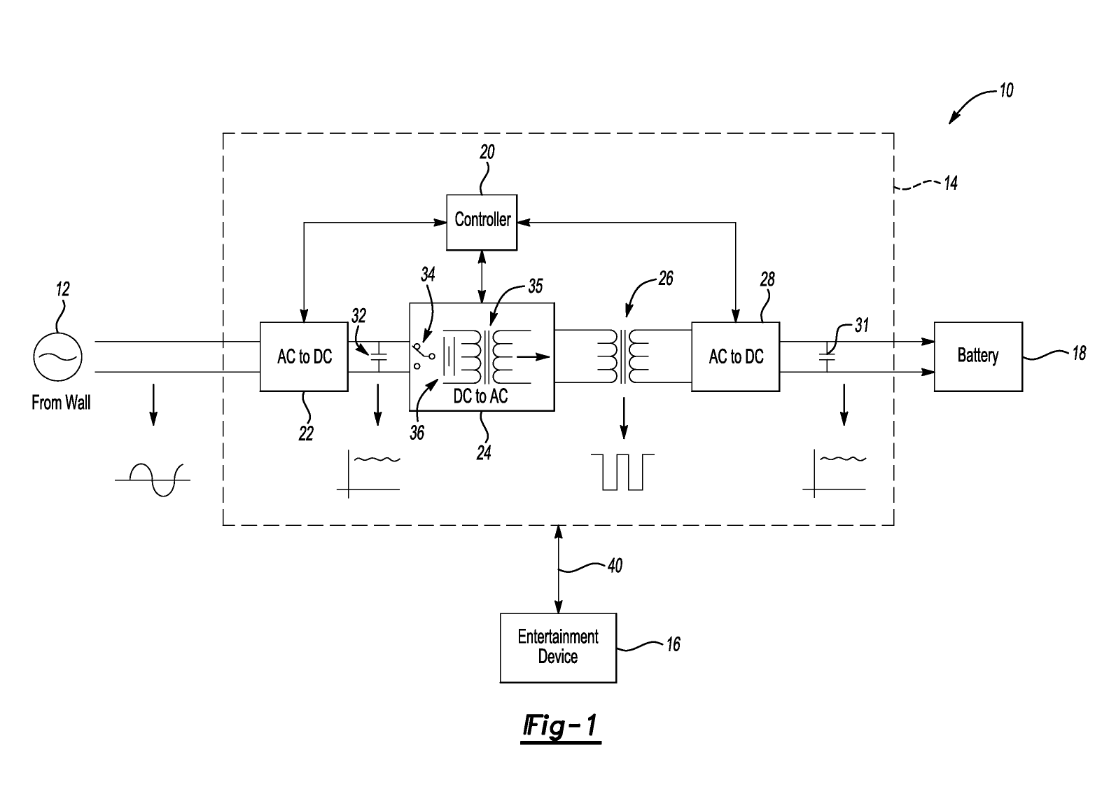

The embodiments of the present invention as set forth in FIGS. 1-5 generally illustrate and describe a plurality of controllers (or modules), or other electrically based components. All references to the various controllers and electrically based components and the functionality provided for each, are not intended to be limited to encompassing only what is illustrated and described herein. While particular labels may be assigned to the various controller(s) and/or electrical component(s) that are disclosed, such labels are not intended to limit the scope of operation for the controllers and/or the electrical components. The controllers may be combined with each other and/or separated in any manner based on the particular type of electrical architecture that is desired or intended to be implemented in the vehicle. The controllers and/or electrical components may be combined with each other and/or separated in any manner based on the particular type of electrical architecture that is desired in the vehicle. It is generally recognized that each controller and/or module/device disclosed herein may include, but not limited to, any number of microprocessors, ICs, memory devices (e.g., FLASH, RAM, ROM, EPROM, EEPROM, or other suitable variants thereof), and software which co-act with one another to perform the various functions set forth below.

FIG. 1 depicts a system 10 for controlling at least one switching frequency in a vehicle in accordance to one embodiment of the present invention. The system 10 includes a power conversion circuit 14, an entertainment device 16, and at least one vehicle battery 18. In one example, the power conversion circuit 14 may be implemented as a battery charger. An external power supply 12 positioned in, but not limited to, a building (residential or commercial) or charging station transfers AC energy therefrom to the power conversion circuit 14. The power conversion circuit 14 converts the AC energy into DC energy for the purpose of charging the battery 18.

The power conversion circuit 14 includes a controller 20, a first AC to DC converter 22, a DC to AC converter (or power converter) 24, a transformer 26, and a second AC to DC converter 28. The controller 20 is generally configured to transmit one or more command signals to the AC to DC converter 22, the DC to AC converter 24, and the AC to DC converter 28 to control the operation of these converters. The command signal may include synchronization signals that may set the switching frequency for one or more of these devices. This operation will be discussed in more detail below.

In one example, the power conversion circuit 14 may form a battery charger module. It is recognized however, that the embodiments of the present invention may be applied to any power converter that utilizes a switching frequency to control the operation of at least one power switch. For example, embodiments of the present invention may be implemented in a power inverter within a vehicle. The power inverter may be a device that converts DC energy into AC energy such that the vehicle occupant may be able to power an AC powered portable device with the AC energy while in the vehicle.

In general, the first AC to DC converter 22 receives the AC energy from the external power supply 12. The first AC to DC converter 22 converts the AC energy into DC energy (or bulk DC energy). The bulk DC energy provides a reservoir of DC power. A capacitor 30 stores the DC energy for consumption by the DC to AC converter 24. The DC to AC converter 24 receives the bulk DC energy and converts such DC input into an AC output that is shaped in the form of a square wave output.

The DC to AC converter 24 includes a transformer 35 having a primary winding and a secondary winding, at least one power switch 34 and a power supply 36. It is recognized that the power switch may be implemented as a transistor or other suitable device. The controller 20 is configured to control particular switching frequency of the at least one power switch 34. For example, the at least one power switch 34 is operably coupled to the power supply 36 and to a center tap of the primary winding. The controller 20 controls the at least one power switch 34 such that the switch 34 may be rapidly switched back and forth to allow current to flow back to the DC source (e.g., capacitor 30) via two alternate paths (e.g., one path from one end of the primary and the other path from the other end of the primary). The change in direction of current in the primary winding of the transformer 35 causes the secondary winding to provide the AC output therefrom. The AC output is generally a square shaped output.

The transformer 26 receives and increases the AC voltage output. The AC to DC converter 28 receives the increased AC voltage and converts the same into an increased DC voltage. The AC to DC converter 28 controls the flow of the increased DC voltage into a capacitor 31. The capacitor 31 discharges the increased DC voltage to the battery 28 for storage purposes. In general, the increased DC voltage may be 400 V or other suitable value.

The conversion chain described above (e.g., AC to DC converter 22, the DC to AC converter 24, and the AC to DC converter 28) may isolate the input AC energy (e.g., from the external power supply 12) and the final DC output (e.g., from the power conversion circuit 14). While the AC input from the external power supply 12 may be provided directly to the transformer 26 due the low frequency (e.g., 50 or 60 Hz) of a common power system, the size of the transformer 26 may be large when compared to what may be needed when high switching frequency is used.

It is recognized that the switching frequency as performed by the DC to AC converter 24 may generate electromagnetic interference (EMI). Such EMI may affect the performance of one or more electrical devices in the vehicle. For example, an entertainment device 16 positioned in the vehicle may have its performance affected due to such EMI. The entertainment device 16 may be a radio or other device that is capable of transmitting audio and/or video signals to one or more occupants in the vehicle. The presence of EMI may degrade the transmission of the audio and/or video signals from the entertainment device 16. It is contemplated that in order to minimize or reduce the effects of the EMI that is caused by the switching frequency exhibited by the DC to AC converter 24, the switching frequency of the power switches 34 may be adjusted such that the switching frequency is moved away from the frequency at which the entertainment device 16 is tuned to. In other words, the power conversion circuit 14 ensures that its switching frequency does not interfere with the frequency reception (e.g., AM/FM) of the entertainment device 16.

The power conversion circuit 14 may be operably coupled to the entertainment device 16 via a communication data bus 40. The communication data bus 40 may be, but not limited to, a high/medium speed controller area network (CAN) or Local Interconnect Network (LIN). In general, the power converter 14 and the entertainment device 16 may communicate with one another via data messages that are transmitted in binary form over the communication bus. The entertainment device 16 may transmit frequency information corresponding to a channel in which the entertainment device 16 is tuned to when transmitting the audio and/or videos signal. Such information may be transmitted over the bus 40. The controller 20 may control the DC to AC converter 24 to adjust the switching frequency of the power switch 34 so that the harmonics attributed to the switching frequency of the power switch 34 is moved away from harmonics of the frequency information that is being used by the entertainment device 16. It is recognized that the controller 20 may control any device that utilizes a power switch and switching frequency such that the harmonics of the switching frequency for the power switch is moved away from the harmonics of the frequency information that is being used by the entertainment device. The controller 20 may selectively control the switching frequency of the power switch 34 in real time based on the frequency reception of the entertainment device 16.

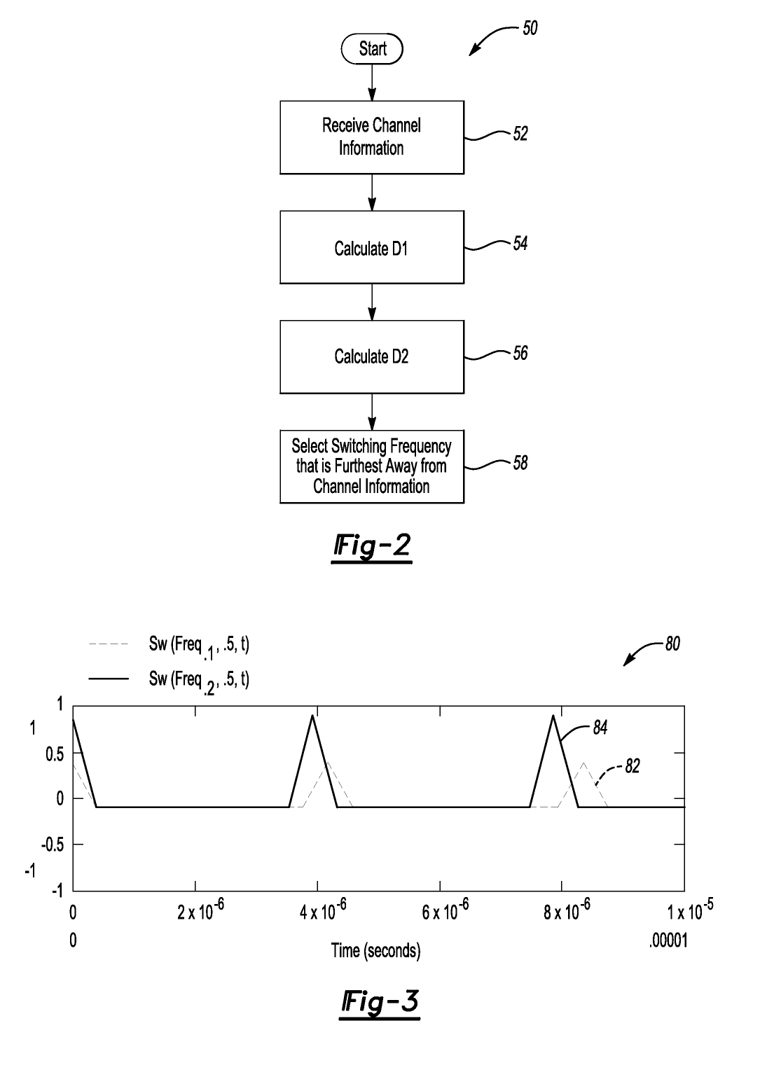

FIG. 2 depicts a method 50 for controlling the switching frequency of the power converter 24 in accordance to one embodiment of the present invention. One or more of the operations described below may be modified, omitted or rearranged as needed based on the desired criteria of a particular implementation.

In operation 52, the controller 20 receives the frequency information from the entertainment device 16 over the bus 40. For example, in the event the occupant has tuned the entertainment device 16 to an AM station, the entertainment device 16 transmits frequency information corresponding to the tuned AM station to the controller 20.

In operation 54, the controller 20 calculates a first distance (or separation) value of the switching frequency that is being used to switch the power switch 34 of the power converter 24 and the frequency information of the AM station. For example, the controller 20 may monitor the harmonics generated due to the switching frequency that is currently being used to switch the power switch 34 and the harmonics generated as a result of the entertainment device 16 being tuned to a particular frequency. The first distance value generally corresponds to a distance between a first set of harmonics that are attributed to the current switching frequency and a second set of harmonics that may be attributed to the frequency in which the entertainment device 16 is tuned to.

In operation 56, the controller 20 calculates a second minimum frequency distance (or separation) value between the closest harmonic of a switching frequency that is either randomly selected or preselected and that could be used to switch the power switch 34 of the power converter 24 and the frequency information of the AM station. For example, the controller 20 may monitor the harmonics that are generated by the randomly or preselected switching frequency and the harmonics generated as a result of the frequency information that the entertainment device 16 is tuned to. The second frequency distance value generally corresponds to a distance between the first set of harmonics that are attributed to the randomly selected or pre-selected switching frequency and the second set of harmonics that may be attributed to the frequency in which the entertainment device 16 is tuned to.

In operation 58, the controller 20 selects the distance value that is the largest. For example, if the first distance value is greater than the second distance value, then the controller 20 may continue to use the current switching frequency to switch the power switch 34. If the second distance value is greater than the first distance value, then the controller 20 selects randomly selected or pre-selected frequency as the switching frequency to control the power switch 34.

FIG. 3 depicts an example of a time domain plot 80 for a first switching frequency and a second switching frequency. Waveform 82 depicts the time domain for the first switching frequency. Waveform 84 depicts the time domain for the second switching frequency. As exhibited, the waveforms 82 and 84 are at slightly different frequencies from one another.

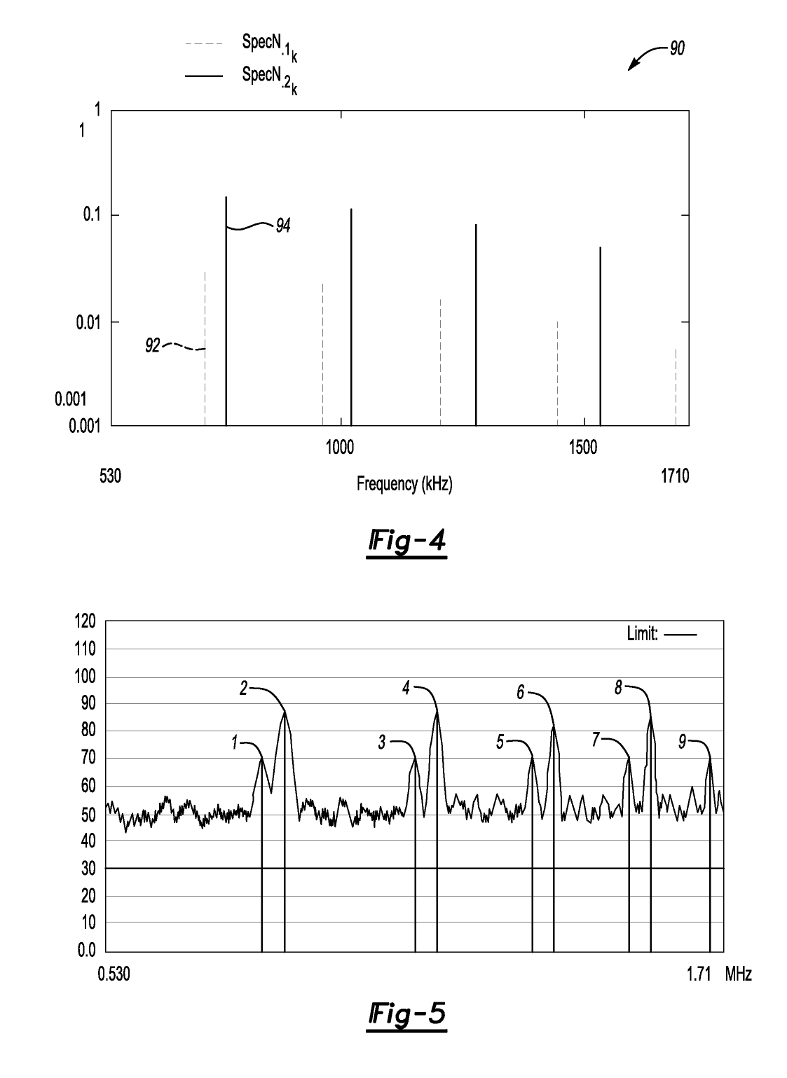

FIG. 4 depicts an example of a frequency domain plot 90 for the first switching frequency and the second switching frequency. Waveform 92 depicts the frequency domain for the first switching frequency (e.g., the first switching frequency as illustrated in waveform 92 is generally 245 KHz). Waveform 94 depicts the frequency domain for the second switching frequency (e.g., the second switching frequency as illustrated in waveform 94 is generally 255 KHz).

FIG. 5 depicts test measurement data obtained from the DC to AC converter 24 in one example. Peaks 1, 3, 5, 7 and 9 correspond to harmonics of a first switching frequency. Peaks 2, 4, 6, and 8 correspond to harmonics of a second switching frequency. These harmonics may be selectively moved closer or apart from one another by adjusting the switching frequencies accordingly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for controlling a switching frequency of at least one power switch in a vehicle, the apparatus comprising:
a power conversion circuit including at least one power switch and being configured to:
convert a first energy signal into a second energy signal;
control the at least one power switch to operate at a first switching frequency while converting the first energy signal into the second energy signal, the first switching frequency generating a first set of harmonics;
receive frequency information from an entertainment device, the frequency information generating a second set of harmonics;
select a second switching frequency, the second switching frequency generating a third set of harmonics; and
determine whether to control the at least one power switch to operate at one of the first switching frequency and the second switching frequency based on a distance measurement using the first set of harmonics, the second set of harmonics, and the third set of harmonics.

2. The apparatus of claim 1 wherein the power conversion circuit is further configured to measure a distance between the first set of harmonics and the second set of harmonics to generate a first distance value.

3. The apparatus of claim 2 wherein the power conversion circuit is further configured to measure a distance between the second set of harmonics and the third set of harmonics to generate a second distance value.

4. The apparatus of claim 3 wherein the power conversion circuit is further configured to compare the first distance value to the second distance value.

5. The apparatus of claim 4 wherein the power conversion circuit is further configured to control the at least one power switch to operate at the first switching frequency if the first distance value is greater than the second distance value.

6. The apparatus of claim 4 wherein the power conversion circuit is further configured to control the at least one power switch to operate at the second switching frequency if the second distance value is greater than the first distance value.

7. The apparatus of claim 1 wherein the frequency information corresponds to one of a frequency modulated (FM) channel and an amplitude modulated (AM) channel.

8. The apparatus of claim 1 wherein the power conversion circuit receives the frequency information over a data communication bus.

9. The apparatus of claim 8 wherein the data communication bus includes one of a controller area network (CAN) and a local interconnect network (LIN).

10. A method for controlling a switching frequency of at least one power switch in a vehicle, the method comprising:
converting a first energy signal into a second energy signal;
controlling at least one power switch to operate at a first switching frequency while converting the first energy signal into the second energy signal, the first switching frequency generating a first set of harmonics;
receiving frequency information from an entertainment device, the frequency information generating a second set of harmonics;
selecting a second switching frequency, the second switching frequency generating a third set of harmonics; and
determining whether to control the at least one power switch to operate at one of the first switching frequency and the second switching frequency based on a distance measurement using the first set of harmonics, the second set of harmonics, and the third set of harmonics.

11. The method of claim 10 wherein determining whether to control the at least one power switch further comprises measuring a distance between the first set of harmonics and the second set of harmonics to generate a first distance value.

12. The method of claim 11 further comprising measuring a distance between the second set of harmonics and the third set of harmonics to generate a second distance value.

13. The method of claim 12 further comprising comparing the first distance value to the second distance value.

14. The method of claim 13 further comprising controlling the at least one power switch to operate at the first switching frequency if the first distance value is greater than the second distance value.

15. The method of claim 13 further comprising controlling the at least one power switch to operate at the second switching frequency if the second distance value is greater than the first distance value.

16. The method of claim 10 wherein the frequency information corresponds to one of a frequency modulated (FM) channel and an amplitude modulated (AM) channel.

17. An apparatus for controlling a switching frequency of at least one power switch in a vehicle, the apparatus comprising:
a power conversion circuit including at least one power switch and being configured to:
convert a first energy signal into a second energy signal;
control at least one power switch to operate at a first switching frequency while converting the first energy signal into the second energy signal, the first switching frequency generating a first set of harmonics;
receive frequency information from an entertainment device, the frequency information generating a second set of harmonics;
select a second switching frequency, the second switching frequency generating a third set of harmonics;
measure a distance between the first set of harmonics and the second set of harmonics to generate a first distance value;
measure a distance between the second set of harmonics and the third set of harmonics to generate a second distance value;
compare the first distance value to the second distance value; and
control the at least one power switch to operate at one of the first switching frequency and the second switching frequency based on the comparison.

18. The apparatus of claim 17 wherein the power conversion circuit is further configured to control the at least one power switch to operate at the first switching frequency in response to determining that the first distance value is greater than the second distance value.

19. The apparatus of claim 17 wherein the power conversion circuit is further configured to control the at least one power switch to operate at the second switching frequency in response to determining that the second distance value is greater than the first distance value.

20. The apparatus of claim 17 wherein the frequency information corresponds to one of a frequency modulated (FM) channel and an amplitude modulated (AM) channel.
